(19) United States
(12) Patent Application Publication
(10) Pub. No.: US 2006/0168578 A1
(43) Pub. Date: Jul. 27, 2006

(54) Methods and systems for managing a mobile client in a client-server system connected via a public network

(75) Inventor: Jan Vorlicek, Prague 9 (CZ)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: U-Turn Media Corporation, Denver, CO (US)

(21) Appl. No.: 11/180,305

(22) Filed: Jul. 12, 2005

Related U.S. Application Data
(60) Provisional application No. 60/646,323, filed on Jan. 21, 2005.
(60) Provisional application No. 60/646,319, filed on Jan. 21, 2005.

(51) Int. Cl. G06F 9/44

(52) U.S. Cl. 717/168

(57) ABSTRACT

Methods and systems are provided for managing a client and/or server in a client-server system. An information request that includes a current version identifier of a software application resident on a client is transmitted from the client to a server. An update of the software application is received at the client from the server in response to a determination by the server that the update of the software application is available for the current version of the software application resident on the client. The software application is automatically updated on the client by executing the received update.

### CROSS-REFERENCES TO RELATED APPLICATIONS

This application is a nonprovisional of, and claims the benefit of the filing date of, each of the following provisional applications, both of which are incorporated herein by reference for all purposes: U.S. Prov. Appl. No. 60/646,323, entitled “SYSTEM AND METHOD FOR AUTHENTICATION OF A SERVICE REQUEST BY A MOBILE CLIENT IN A CLIENT-SERVER SYSTEM CONNECTED VIA UNSECURE PUBLIC NETWORKS,” filed Feb. 23, 2005 by Jan Vorlicek; and U.S. Prov. Pat. Appl. No. 60/646,319, entitled “SYSTEM AND METHOD FOR AUTOMATIC APPLICATION UPDATE FOR DOWNLOAD OR STREAMING OF RICH CONTENT IN A MOBILE CLIENT,” filed Feb. 23, 2005 by Jan Vorlicek.

### BACKGROUND OF THE INVENTION

This application relates generally to client-server systems. More specifically, this application relates to a client-server system used for delivery of content via a public network.

In recent years, there has been a significant increase in the use of handheld electronic devices. This increase has generally been coupled with steady technological advances that allow for increased processing power and greater memory, as well as the inclusion of more sophisticated software to operate the devices. These technological advances have allowed wireless service providers to seek innovative new functionalities that may be provided to attract increased market share.

One functionality that has generated interest among owners of handheld electronic devices is the streaming of multimedia to such devices. One example of multimedia that may be provided to such devices is motion video sequences that are streamed from a central content-delivery system to a mobile electronic device such as a mobile telephone, personal digital assistant, or the like. There are, however, a number of challenges that arise when faced with actual implementation of such capabilities. These challenges include the need to integrate the provision of multimedia content into many different existing communications systems, which are already generally in full operation, as well as the need to accommodate upgrades in these systems as new equipment becomes available, configurations are changed, and the like.

There is accordingly a general need in the art for improved methods and systems that accommodate such needs.

### BRIEF SUMMARY OF THE INVENTION

Embodiments of the invention provide methods and systems for managing a client and/or server in a client-server system. An information request that includes a current version identifier of a software application resident on a client is transmitted from the client to a server. An update of the software application is received at the client from the server in response to a determination by the server that the update of the software application is available for the current version of the software application resident on the client. The software application is automatically updated on the client by executing the received update.

The information may be transmitted automatically in response to a user initiating a standard function of the client. For example, in several embodiments, the client is adapted to receive content delivered from the server. In one such embodiment, the content is organized according to a menu, with the information requested being transmitted in response to a user request for the menu. In such an embodiment, the menu may subsequently be received at the client from the server and displayed to the user on the client.

In other embodiments where the client is adapted to receive content delivered from the server, an authorization request may be transmitted from the client to the server over a first channel between the client and the server. An authorization string is received at the client from the server over the first channel. A request for specified content is transmitted from the client to the server over a second channel between the client and the server; the second channel is distinct from the first channel and the request for specified content includes the authorization string. The specified content is received at the client from the server over the second channel.

In some instances, a time stamp may be received at the client from the server with the authorization string. The time stamp is then transmitted from the client to the server with the request for specified content. The specified content is received at the client from the server in response to a determination by the server that the time stamp differs from a current time by less than a predetermined time interval. The time stamp may advantageously be encrypted.

In some embodiments, the client is one of a plurality of mobile clients that together with the server define a client-server system. In addition, different types of content may be received from the server, including streamed content.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 shows an overview of elements of a client-server system that may be used for delivery of multimedia in a mobile client environment;

FIG. 2A provides a schematic overview of a content-delivery system that may form part of the client-server system of FIG. 1;

FIG. 2B provides a schematic illustration of hardware components that may be included in mobile clients that form part of the client-server system of FIG. 1;

FIG. 3A illustrates use of a mobile client within the client-server environment of FIG. 1 in one embodiment to request content from the server;

FIG. 3B is a flow diagram summarizing methods for requesting content from the server in an embodiment that corresponds to FIG. 3A;

FIG. 4A illustrates use of a mobile client within the client-server environment of FIG. 1 in another embodiment to request content from the server;

FIG. 4B is a flow diagram summarizing methods for requesting content from the server in an embodiment that corresponds to FIG. 4A;

FIGS. 5A and 5B illustrate use of a mobile client to request menu viewing in preparation for viewing media on the mobile client; and

FIG. 5C is a flow diagram summarizing methods corresponding to the embodiments of FIGS. 5A and 5B.

### DETAILED DESCRIPTION OF THE INVENTION

Embodiments of the invention provide methods and systems that manage certain operations performed within a mobile-client environment. For example, some embodiments provide methods and systems for requesting content and for authenticating a service request, while other embodiments provide methods and systems for automatically updating applications for downloading or streaming content. References herein to “mobile clients” and to “multimedia” are intended to be broad. For example, a “mobile client” refers to any wireless electronic device that has the capability of receiving content wirelessly. Examples of mobile clients include cellular telephones, personal digital assistants, and the like. “Multimedia” refers to content that includes multiple distinct forms of content; for example, multimedia may include combinations of text, images, graphics, animation, audio, and/or video, and the like. In some instances, references may be made herein to “rich content,” which are intended to refer to content having the capability of user interaction, such as may be provided with applets or with streamed content. “Streamed” content is content that is sent in a substantially continuous stream to a device and is played as it arrives, rather than being fully downloaded to the device and played thereafter. Streamed content may be provided from prerecorded content files or may be distributed as part of a live broadcast feed. In a live broadcast, the content is usually converted to a compressed digital signal and transmitted in multicast fashion by streaming the same file to multiple user devices at substantially the same time.

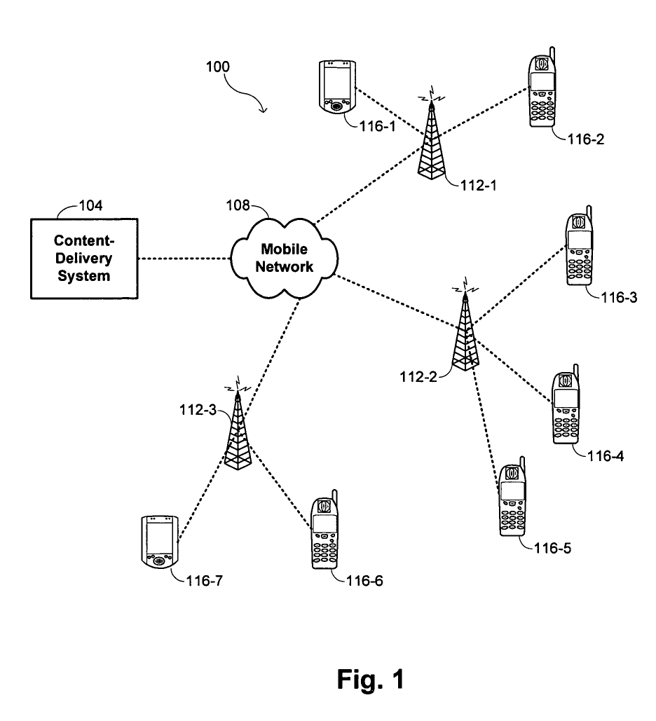

One physical arrangement that may be used to provide content to mobile clients is illustrated in FIG. 1. The client-server system 100 is implemented with a content-delivery system 104 that includes the server and a plurality of remote electronic devices 116 that correspond to the clients. Communications between the content-delivery system and the mobile clients may be effected through radio links, although other types of communications may be used in alternative embodiments. For instance, FIG. 1 shows an embodiment in which communications are made through a mobile network 108 that is itself in communication with a plurality of base stations 112 that are distributed geographically. This arrangement permits each mobile client 116 to communicate with the content-delivery system through one of the base stations 112 depending on the current physical location of the mobile client 116. It also permits the actual communications pathway used to change as the mobile client 116 changes position to move into closer proximity to a different one of the base stations.

The illustration in FIG. 1 emphasizes that the mobile clients may be different types of electronic devices, even in embodiments that use a single mobile network 108, by showing certain of the devices (116-2, 116-3, 116-4, 116-5, and 116-6) as cellular telephones and by showing other of the devices (116-1 and 116-7) as personal digital assistants. In other embodiments, a plurality of mobile networks 108 may interface with the content-delivery system 104. The communications links are shown as dotted lines in the drawing, with the exemplary embodiment illustrating an implementation in which all communications are performed through radio links or through other wireless forms of communication. It will be appreciated, however, that wire-based links may alternatively be used in some embodiments, with certain embodiments using a combination of wire-based and wireless communications. For instance, in one embodiment, the mobile network 108 might implement a wire-based interconnection of the base stations 112 with the content-delivery system, with communications between the base stations 112 and the mobile clients 116 still proceeding wirelessly.

The content that is to be provided to the mobile clients 116 may be stored by the content-delivery system 104, on a subsystem of the content-delivery system 104, or on another system in communication with the content-delivery system 104. The content is made available for access on a specific remote client 116 through a software application installed on the client 116 and configured to connect to the content-delivery system 104. With such a connection, the content is accessed from the content-delivery system 104 and presented to a user of the remote client 116 in a form suitable for that particular device.

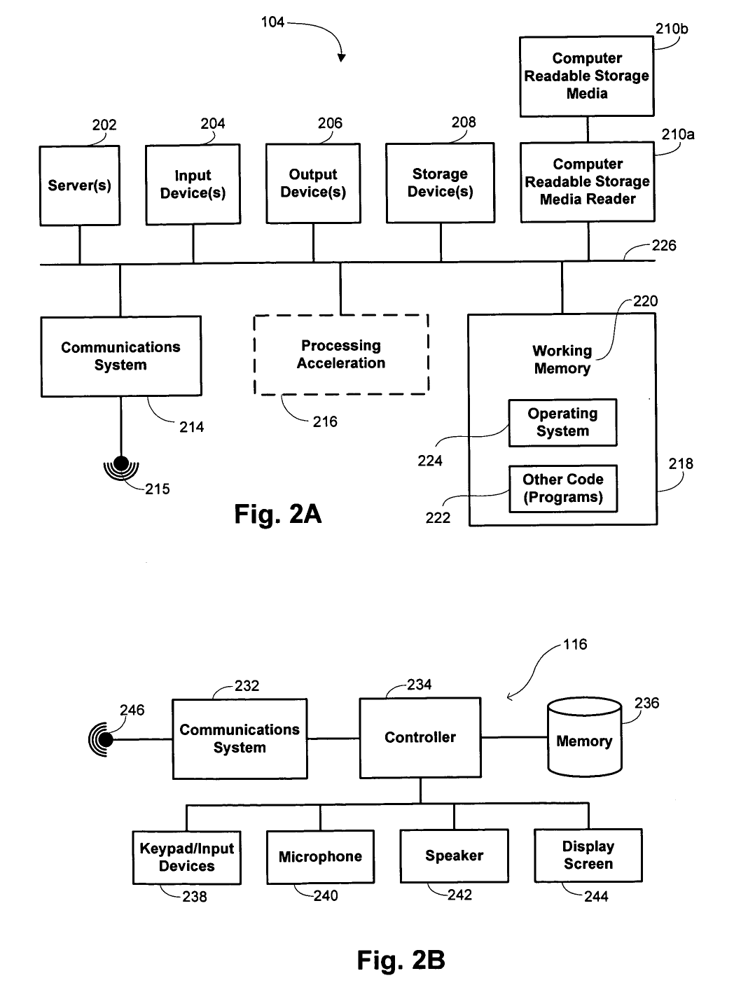

FIGS. 2A and 2B provide exemplary illustrations for structures that may be used by the content-delivery system 104 and by the clients 116 respectively in a particular embodiment. FIG. 2A broadly illustrates how individual system elements of the content-delivery system 104 may be implemented in a separated or more integrated manner. The content-delivery system 104 is shown comprised of hardware elements that are electrically coupled via bus 226, including a server 202, an input device 204, an output device 206; a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged wirelessly through an antenna 215. The content may be stored on the storage device(s) 208.

The content-delivery system 104 also comprises software elements, shown as being currently located within working memory 220, including an operating system 224 and other code 222, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

Operations of the mobile client 116 shown in FIG. 2B are coordinated by a controller 234. The controller is provided in communication with a memory 236 where data used to implement the controller functions may be stored, as well as where downloaded content may be stored. Communications may be received or transmitted wirelessly by an antenna 246 and processed by a communications system 232 provided in communication with the controller 234. The controller 234 may also coordinate other functionality of the mobile client 116. FIG. 2B illustrates an example where the mobile client 116 includes a keypad or other input devices 238, a microphone 240, a speaker 242, and a display screen 244, all of which are provided in communication with and under the control of the controller 234. Such components may be provided, for instance, in embodiments where the mobile client 116 comprises a cellular telephone, although additional components may also be provided in other embodiments.

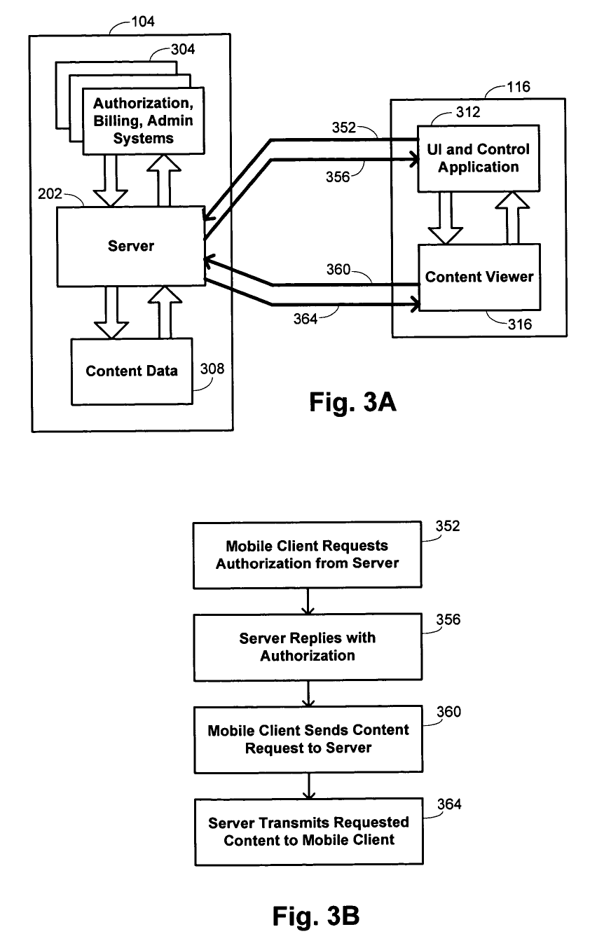

While FIGS. 2A and 2B provided illustrations of hardware structures for the content-delivery system 104 and the remote clients 116, the subsequent drawings use more functional characterizations. For example, FIGS. 3A and 3B respectively provide a schematic diagram and a flowchart that illustrate how a content request may be handled by system. In FIG. 3A, the content-delivery system 104 is shown to have the server 202 interacting functionally with other systems 304 that may include authorization, billing, and administrative systems, as well as having access to content data 308 that may be stored on the storage device(s) 208. The mobile client 116 is shown having two logical application modules, a universal interface and control application (“UICA”) 312 and a content-viewer module 316; it should be understood that the mobile client 116 will generally include additional application modules as well understood by those of skill in the art, with these particular modules being highlighted in the drawings to illustrate certain aspects of the invention.

The blocks of the flow diagram in FIG. 3B are identified with reference numbers that correspond to arrows provided in FIG. 3A to illustrate how the communications are routed within the system. The specific functions that are performed allow the provision of content by the content-delivery system 104 to the remote clients 116 to be integrated into different existing communications systems, even where the communication protocols and network architecture and administration systems differ among systems. Examples of high-level communications protocols that may be used by the client-server arrangement 100 include the Real-Time Streaming Protocol (“RTSP”) or the HyperText Transfer Protocol (“HTTP”), both of which are well known to practitioners in the filed.

FIG. 3B shows a specific sequence of functions that are performed in provisioning the content that is to be supplied. The sequence includes having the mobile client request authorization for particular content at block 352. While the request may be handled by the authorization subsystem 304 of the content-delivery system 104, FIG. 3A shows that the request is initially transmitted from the UICA 312 of the mobile client 116 to the server 202 of the content-delivery system 104. If the determination by the authorization subsystem is that the request is to be authorized, the server 202 replies with an authorization at block 356, FIG. 3A showing that the authorization communication may be transmitted from the server 202 to the UICA 312. After receipt of a positive authorization message, the UICA 312 may generate a content request that is handed off to the content-viewer subsystem. In some embodiments, such a content request may be provided in the form of an RTSP URL, although other forms may be used in embodiments that use different communications protocols. The mobile client 116 sends the content request to the server 202 of the content-delivery system at block 360, with FIG. 3A showing transmission of the content request originating with the content-viewer subsystem 316 and being transmitted to the server 202 of the content-delivery system 104. The server 104 responds to the content request by transmitting the requested content to the mobile client at block 364, with FIG. 3A showing that the transmission may be made from the server 104 to the content-viewer subsystem 316.

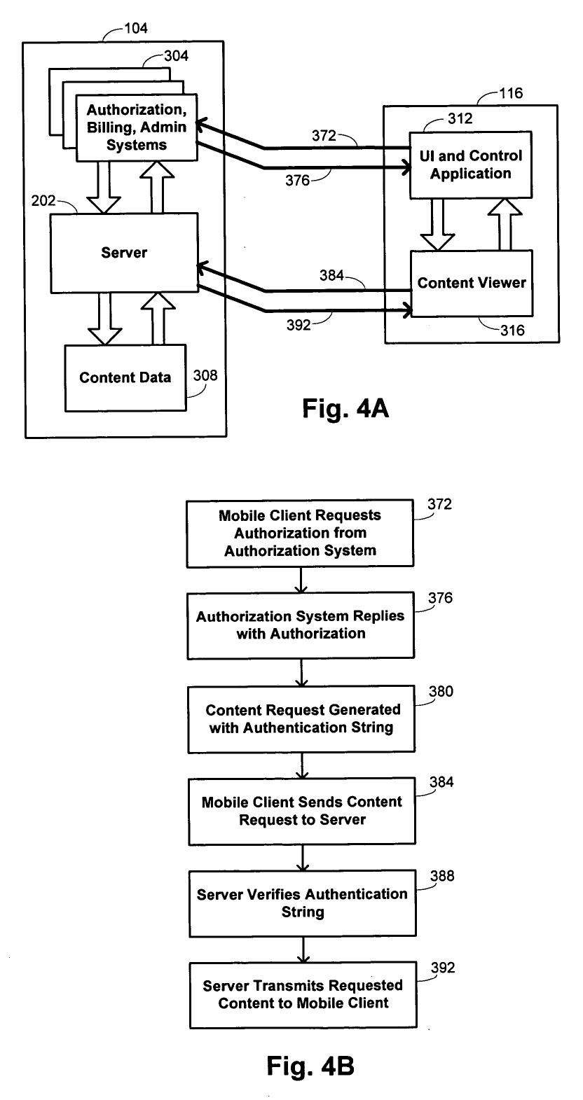

In other embodiments, the authorization request and reply are decoupled from the content request and reply. Such decoupling may advantageously increase applicability of the method to a greater number of architectures for server and authorization, billing, and administration systems. One example of such decoupling is provided with the schematic diagram of FIG. 4A and with the corresponding flow diagram of FIG. 4B. The structures of the content-delivery system 104 and the remote clients 116 is similar to that shown in FIG. 3A, and the drawings again share reference numbers to identify communications paths in FIG. 4A that correspond to functions performed in FIG. 4B.

The general sequence of events remains the same when the authorization request and reply are decoupled from the content request and reply. One difference that manifests the decoupling, however, is that the request for authorization issued at block 372 from the UICA is transmitted directly with an authorization, billing, or administration system 304 that has a separate communications channel or interface from the channel or interface used by the content server 202. The authorization, billing, or administration system 304 replies with the authorization at block 376 over the same separate communications channel or interface. The decoupling is effected by the use of different protocols or separate channel for the authorization request and reply and the subsequent content request and response.

Certain security features may be introduced to account for the fact that such decoupling may permit interception of the content request or misuse of the request by a technically knowledgeable user who records it. These security features may be directed at ensuring that a generated content request is used only once. In particular embodiments, this is achieved by adding an authentication string to the content request that is generated at block 380. For example, in one embodiment the authentication string comprises a time stamp, one convenient time stamp being the current time of receipt of the authorization at block 376. Such a time stamp may be inherent in the communications protocol that is being used for the authorization, such as is the case in embodiments where the communications protocol comprises RTSP. In embodiments where the communications protocol used for the authorization does not inherently include a time stamp, a time stamp may be included as an additional parameter or data item sent as part of the authorization provided at block 376. In some instances, the time stamp may be encrypted with an encryption method having sufficient strength to be resistant to unauthorized attempts to read it. The particular encryption technique used may depend on the system's anticipated exposure to abuse to ensure that it has adequate strength, while at the same time recognizing the general desire to minimize the response time of the mobile client, which is likely to have relatively modest computing power. The resulting authorization string is appended to the content request at block 380, such as by appending the resulting authorization string to an RTSP URL as part of a query-string parameter. In some instances, the query-string parameter may include other identifying information, such as a unique identification number assigned to the remote client.

The mobile client sends the content request to the server 202 from the content-viewer subsystem 316 at block 384. As previously noted, this is done using a separate protocol or on a separate channel from the authorization request as part of the decoupling of this functionality. The server 202 verifies the authentication string at block 388. This may comprise identifying the portion of the received request that corresponds to the authentication string and, in instances where it is encrypted, applying a decryption algorithm that corresponds to the algorithm used to encrypt the string. In embodiments where the authentication string comprises a time stamp, a determination is made whether the time stamp identifies a time that is within a predetermined tolerance T_{c} of the current time on a clock comprised by the server 202. This tolerance may account for anticipated network response time. If the authentication string is verified, the server 202 transmits the requested content to the content-viewer subsystem 316 of the mobile client at block 392. The content viewer 316 may then display the content on the device.

The above methods may be performed to provide a variety of different types of content to the mobile client 116. For example, the content transmitted at block 392 may be downloaded to the mobile client 116 or may be streamed to the mobile client 116 in different embodiments. Furthermore, the content may comprise any type of media, although in certain preferred embodiments in comprises multimedia. In one specific embodiment, the content comprises rich multimedia.

In another specific embodiment, the content available for access by the software installed in the mobile clients 116 is organized such that it is available through a menu structure. For example, the menu structure may reflect logical categories of the content and/or relationships between the categories or between individual content items. A software application installed on the remote client 116 may be used to present information regarding the content structure to a user of the device, such as by identifying names of the categories, titles of the content, summaries of the content, and the like. It is anticipated that certain types of content may change relatively frequently, such as when new video sequences are created and made available to the remote clients 116, when old video sequences are deleted or updated, when new content categories are created and made available to clients 116, when old content categories are deleted, when the categories are changed or their relationships are changed, and the like. The software application that presents the menu information to the user may itself be updated at irregular intervals, such as in response to changes in network configurations or capabilities, in response to new types of content becoming available, in response to improvements in methods of displaying content being developed, in response to fixes developed for the application, and the like.

In some embodiments, the content-viewer subsystem 316 and other applications installed on the mobile client 116 used in presenting the content may be stored in a type of memory suitable for adding, deleting, and/or changing software applications. Correspondingly, the controller 234 of the mobile client 116 may be capable of performing the tasks of adding, deleting, and/or changing these software applications in memory. There are a variety of circumstances under which such capabilities may be useful to change or upgrade the software applications. For example, changes or upgrades may be made to accommodate changes or additions to network capabilities, to fix software bugs, to include newly developed software functionality such as might be provided to improve the quality of the presentation of the content, to accommodate new types of content that might become available, and the like.

Embodiments of the invention avoid certain disadvantages of the prior art in which an operator of the mobile client 116 is required to manually initiate an upgrade of a given software application, such as in response to an advertisement of the availability of the upgrade. A persistent drawback to such arrangements is the general reluctance of operators of the mobile clients 116 to be burdened with the administrative tasks of installing new versions of their applications. Content providers are also burdened with a need to ensure that the content-delivery system 104 and its content are configured to handle out-of-date applications resident on mobile clients 116 for some length of time after a new version of application software has been made available. Furthermore, both the providers and customers may expend significant resources participating in customer-support calls to resolve difficulties users experience in attempting to operate remote clients containing out-of-date software applications.

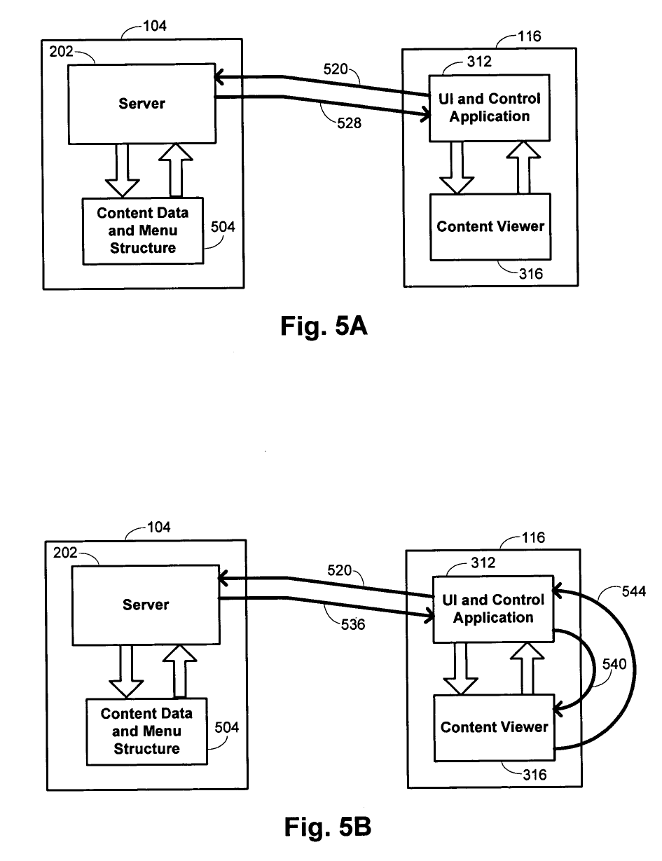

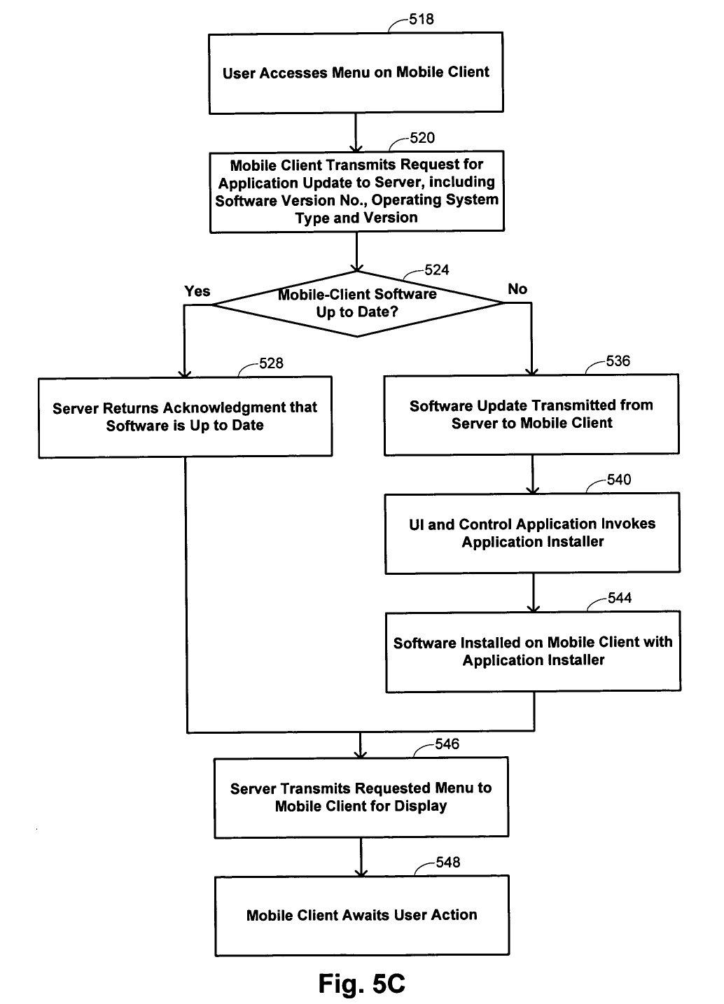

Embodiments of the invention avoid such disadvantages in part by permitting substantially automatic updating of software applications on the remote clients 116 when they become available, without requiring intervention by the users of the remote clients 116. Such embodiments are illustrated with FIGS. 5A-5C, with FIGS. 5A and 5B showing schematic structural diagrams of the content-delivery system 104 and a remote client 116, and FIG. 5C providing a flow diagram illustrating a method for updating an application on a mobile client. Similar to FIGS. 3A-4B, arrows in FIGS. 5A and 5B are identified by reference numbers that correspond to blocks in the flow diagram of FIG. 5C to show explicitly between which modules communications take place in a particular embodiment. The structure of the content-delivery system 104 and mobile client 116 as shown in FIGS. 5A and 5B is similar to the structure shown in FIGS. 3A and 3B. Again, however, the identification of certain modules in these drawings is not intended to be exhaustive since other modules that perform other functions may be included; for example, FIGS. 5A and 5B do not explicitly show the authorization, billing, and administration systems 304 that were discussed in connection with FIGS. 3A and 4A. The flow diagram of FIG. 5C includes two branches, with FIG. 5A illustrating functions performed on the left branch and FIG. 5B illustrating functions performed on the right branch.

A check for an application update may be initiated as a result of a user accessing the menu function on his mobile client 116 at block 518. While this is an example of an initiation action, other actions may result in initiation of the check in different embodiments. The act of accessing the menu function causes the UICA 312 to transmit a request for the menu to the server 202 at block 520, as indicated by the arrow 520 in both FIGS. 5A and 5B. The request automatically includes information that identifies the current application and/or the current operating system being used by the remote client. For example, in the illustrated embodiment, the request includes a specification of the version number of the UICA software as well as an identification of the operating-system type and its version number. The response of the server 202 may depend on whether this information is consistent with the application being current, as checked at block 524.

If that comparison indicates that the application is current, the server 202 may optionally return an acknowledgment of that determination back to the UICA 312 at block 528, although in some embodiments no explicit acknowledgment is returned. This is reflected in FIG. 5A. If the comparison instead indicates that the application is not current, the server 202 initiates transmission of an update to the mobile client 116 at block 536, as indicated in FIG. 2B. This is usually preceded by a notification to the mobile client 116 that a software update is required so that the mobile client 116 is prepared to receive the update. In response to receipt of this notification, the mobile client 116 invokes a software application installer at block 540, with the software then being installed on the mobile client 116 with the application installer at block 544. This may cause a new UICA 312 to be installed in place of the out-of-date UICA 312. The user operating the mobile client 116 may be notified that the software has been updated.

In either case, the requested menu is transmitted by the server 202 at block 546 for display on the mobile client 116, with the mobile client 116 then awaiting user action at block 548. Further action by the user may be implemented to deliver content to the mobile client 116 as described above, with the additional functionality enabled by the menu structure. Display of the menu by the UICA 312 permits the user to navigate through the menu categories and items, allowing the user to view desired content by using the content-viewer 316 and other subsystems and applications resident on the mobile client 116, and by communicating with the server 202 directly or indirectly with other subsystems and applications.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of managing a client in a client-server system, the method comprising:
transmitting, from the client to a server, an information request that includes a current version identifier of a software application resident on the client;
receiving an update of the software application at the client from the server in response to a determination by the server that the update of the software application is available for the current version of the software application resident on the client; and
automatically updating the software application on the client by executing the received update.

2. The method recited in claim 1 wherein transmitting the information request is performed automatically in response to a user initiating a standard function of the client.

3. The method recited in claim 1 wherein the client is adapted to receive content delivered from the server.

4. The method recited in claim 3 wherein:
the content is organized according to a menu; and
transmitting the information request is initiated in response to a user request for the menu,
the method further comprising:
receiving the menu at the client from the server; and
displaying the menu to the user on the client.

5. The method recited in claim 3 further comprising:
transmitting an authorization request from the client to the server over a first channel between the client and the server;
receiving an authorization string at the client from the server over the first channel;
transmitting a request for specified content from the client to the server over a second channel between the client and the server, the second channel being distinct from the first channel and the request for specified content including the authorization string; and
receiving the specified content at the client from the server over the second channel.

6. The method recited in claim 5 further comprising:
receiving a time stamp at the client from the server with the authorization string; and
transmitting the time stamp from the client to the server with the request for specified content,
wherein the specified content is received at the client from the server in response to a determination by the server that the time stamp differs from a current time by less than a predetermined time interval.

7. The method recited in claim 6 wherein transmitting the time stamp from the client to the server comprises transmitting an encrypted version of the time stamp from the client to the server.

8. The method recited in claim 5 wherein receiving the specified content comprises receiving the specified content as streamed content.

9. A method of operating a server in a client-server system, the method comprising:
receiving, at the server from a client, an information request that includes a current version identifier of a software application resident on the client;
determining, by the server, that an update of the software application is available for the current version of the software application resident on the client; and
transmitting the update of the software application from the server to the client for automatic updating of the software application by the client with the transmitted update.

10. The method recited in claim 9 further comprising transmitting content from the server to the client for display to a user on the client.

11. The method recited in claim 9 further comprising:
receiving an authorization request at the server from the client over a first channel between the client and the server;
transmitting an authorization string to the client from the server over the first channel;
receiving a request for specified content at the server from the client over a second channel between the client and the server, the second channel being distinct from the first channel and the request for specified content including the authorization string,
wherein transmitting content from the server to the client comprises transmitting the specified content from the server to the client over the second channel.

12. The method recited in claim 11 further comprising:
transmitting a time stamp to the client from the server with the authorization string;
receiving the time stamp at the server from the client with the request for specified content; and
verifying that the received time stamp differs from a current time at the server by less than a predetermined time interval.

13. The method recited in claim 12 wherein receiving the time stamp at the server from the client comprises receiving an encrypted version of the time stamp, the method further comprising decrypting the encrypted version of the time stamp at the server.

14. The method recited in claim 11 wherein transmitting the specified content comprising transmitting the specified content as streamed content.

15. A client-server system comprising:
a server; and
a plurality of mobile clients, each such mobile client being adapted to be carried by a user and to communicate wirelessly the server, each such mobile client further having a computer-readable storage medium that includes:
instructions to transmit an information request to the server in response to a user initiating a standard function of the each such mobile client, the information request including a current version identifier of the software application resident on the each such mobile client;
instructions to receive an update of the software application at the each such mobile client from the server in response to a determination by the server that the update of the software application as available for the current version of the software application resident on the each such mobile client; and
instructions to automatically update the software application on the each such mobile client by executing the received update.

16. The client-server system recited in claim 15 wherein:
the server is adapted to transmit content to each of the mobile clients;
the content is organized according to a menu; and
the instructions to transmit the information request are executed in response to a user request for the menu.

17. The client-server system recited in claim 15 wherein:
the server is adapted to transmit content to each of the mobile clients; and
the computer-readable storage medium further includes:
instructions to transmit an authorization request from the each such mobile client to the server over a first channel between the each such mobile client and the server;
instructions to receive an authorization string at the each such mobile client from the server over the first channel;
instructions to transmit a request for specified content from the each such mobile client to the server over a second channel between the each such mobile client and the server, the second channel being distinct from the first channel and the request for specified content including the authorization string; and
instructions to receive the specified content at the each such mobile client form the server over the second channel.

18. The client-server system recited in claim 17 wherein the computer-readable storage medium further includes:
instructions to receive a time stamp at the each such mobile client from the server with the authorization string;
instructions to transmit the time stamp from the each such mobile client to the server with the request for specified content,
wherein the specified content is received at the each such mobile client from the server in response to a determination by the server that the time stamp differs from a current time by less than a predetermined time interval.

19. The client-server system recited in claim 18 wherein the instructions to transmit the time stamp from the each such mobile client to the server comprise instructions to transmit an encrypted version of the time stamp from the each such mobile client to the server.

20. The client-server system recited in claim 17 wherein the instructions to receive the specified content comprise instructions to receive the specified content as streamed content.
